(19) United States
(12) Patent Application Publication
(10) Pub. No.: US 2015/0058295 A1
(43) Pub. Date: Feb. 26, 2015

(54) Data Persistence Processing Method and Apparatus, and Database System

(71) Applicant: Huawei Technologies Co., Ltd., Shenzhen (CN)

(72) Inventors: Vinoth Veeraraghavan, Shenzhen (CN); Yongfei Peng, Shenzhen (CN); Shangde Yang, Shenzhen (CN)

(21) Appl. No.: 14/529,501

(22) Filed: Oct. 31, 2014

Related U.S. Application Data
(63) Continuation of application No. PCT/CN2012/083305, filed on Oct. 22, 2012.

(30) Foreign Application Priority Data
May 2, 2012 (CN) 201210133474.4

(51) Int. Cl. G06F 11/14

(52) U.S. Cl. CPC G06F 11/1451; G06F 11/1461; G06F 2201/84; G06F 2201/80
USPC 707/649

(57) ABSTRACT

A data persistence processing method is disclosed, where the method includes: adding the dirty page identifier to a checkpoint queue each time when a dirty page is generated in a database system memory; determining an active group and a current group in the checkpoint queue, and successively dumping, to a disk, the dirty pages corresponding to the active group on a preset checkpoint occurrence occasion, where the dirty pages are currently prepare to be dumped to the disk, and a group inserted with a dirty page that is newly added is the current group; and determining a next active group if last dumping is completed, and successively dumping, to the disk, the dirty pages corresponding to the next active group on the checkpoint occurrence occasion. The method improves the dumping efficiency of the dirty pages.

### CROSS-REFERENCE TO RELATED APPLICATIONS

This application is a continuation of International Application No. PCT/CN2012/083305, filed on Oct. 22, 2012, which claims priority to Chinese Patent Application No. 201210133474.4, filed on May 2, 2012, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of computer technologies, and in particular, to a data persistence processing method and apparatus, and a database system.

### BACKGROUND

Compared with a disk, a memory can provide a higher throughput and a quicker response. Generally, a database system preferentially stores data in a memory; for example, data that is complex for reading and writing, so as to improve a speed of data reading and writing, and implement caching. A database system generally uses a page as a unit of caching. When a process modifies data in a cache, the page is marked as a dirty page by a kernel, and the database system writes data of the dirty page into a disk at a proper time, so as to maintain that the data in the cache and the data in the disk are consistent.

A checkpoint mechanism is a mechanism that allows a database to recover after a fault occurs. A traditional checkpoint mechanism is also called a full checkpoint mechanism, and all dirty pages in a checkpoint queue are transferred and stored in a disk at a time. When the checkpoint mechanism is used for performing data persistence processing, to ensure consistency between data in a memory and data in a disk, the entire checkpoint queue requires to be locked during the whole period of data persistence processing. In other words, a normal transaction operation of a user is prevented for a relatively long period.

To overcome a disadvantage that the traditional full checkpoint mechanism affects execution of a normal transaction, a mechanism called “fuzzy checkpoint” is put forward. A fuzzy checkpoint mechanism aims to copy a generated dirty page to a disk step by step; thereby impact on a normal transaction operation of a user caused by data persistence processing is reduced. However, there is a lack of effective solutions in the prior art to specifically implement the fuzzy checkpoint mechanism.

### SUMMARY

Embodiments of the present invention provide a data persistence processing method and apparatus, and a database system, so as to improve dumping efficiency of dirty pages to a certain extent.

According to one aspect, an embodiment of the present invention provides a data persistence processing method, including: adding, to a checkpoint queue each time when a dirty page is generated in a database system memory, a page identifier respectively corresponding to each generated dirty page; determining an active group and a current group in the checkpoint queue, where the page identifiers that are in the checkpoint queue and are respectively corresponding to multiple dirty pages to be currently dumped to a disk form the active group, and a group inserted with a dirty page that is newly added in the checkpoint queue is the current group; successively dumping, to a data file of the disk, each dirty page that is corresponding to each page identifier included in the active group on a preset checkpoint occurrence occasion; and determining a next active group in the checkpoint queue if dumping of the dirty pages related to the active group is completed, and successively dumping, to a data file of the disk, each dirty page that is corresponding to each page identifier included in the next active group on the checkpoint occurrence occasion.

According to another aspect, an embodiment of the present invention further provides a data persistence processing apparatus, including: a checkpoint queue maintaining unit configured to add, to a checkpoint queue each time when a dirty page is generated in a database system memory, a page identifier respectively corresponding to each generated dirty page; a group processing unit configured to determine an active group and a current group in the checkpoint queue, where the page identifiers that are in the checkpoint queue and are respectively corresponding to multiple dirty pages to be currently dumped to a disk form the active group; and a group inserted with a dirty page that is newly added in the checkpoint queue is the current group; and a dirty page bulk dumping unit configured to successively dump, to a data file of the disk, each dirty page that is corresponding to each page identifier included in the active group on a preset checkpoint occurrence occasion; the group processing unit is further configured to determine a next active group in the checkpoint queue if dumping of the dirty pages related to the active group is completed; and the dirty page bulk dumping unit is further configured to successively dump, to a data file of the disk, each dirty page that is corresponding to each page identifier included in the next active group on the checkpoint occurrence occasion.

According to still another aspect, an embodiment of the present invention further provides a database system, including: a disk file, a memory database, and a database management system, where the database management system is configured to manage data stored in the memory database; the database management system includes the foregoing data persistence processing apparatus; and the data persistence processing apparatus is configured to dump the data stored in the memory database to the disk file.

In the data persistence processing method and apparatus, and the database system provided by the embodiments of the present invention, a checkpoint queue is maintained dynamically; page identifiers that are in the checkpoint queue and are corresponding to multiple dirty pages to be currently dumped to a disk are used as an active group, and a group inserted with a dirty page that is newly added in the checkpoint queue is used as a current group; on each checkpoint occurrence occasion, dirty pages corresponding to each page identifier included in an active group are successively dumped to a database of the disk; and after dumping of the dirty pages corresponding to each page identifier included in an active group is completed, a next active group is determined in the checkpoint queue, so as to successively dump each dirty page that is corresponding to each page identifier included in the next active group to a data file of the disk on a next checkpoint occurrence occasion. By circularly performing processing, dirty pages are dumped to the disk in groups and in bulk according to the checkpoint occurrence occasion, thereby improving dumping efficiency of the dirty pages on the basis that the dumping of the dirty pages has small impact on a normal transaction operation.

### BRIEF DESCRIPTION OF THE DRAWINGS

To describe the technical solutions in the embodiments of the present invention more clearly, the following briefly introduces the accompanying drawings required for describing the embodiments. The accompanying drawings in the following description show merely some embodiments of the present invention, and persons of ordinary skill in the art may still derive other drawings from these accompanying drawings without creative efforts.

FIG. 1 is a flowchart of a data persistence processing method according to an embodiment of the present invention;

FIG. 2A is example 1 of checkpoint queue grouping according to an embodiment of the present invention;

FIG. 2B is an example of adding a page identifier to a checkpoint queue according to an embodiment of the present invention;

FIG. 2C is example 2 of checkpoint queue grouping according to an embodiment of the present invention;

FIG. 2D is example 3 of checkpoint queue grouping according to an embodiment of the present invention;

FIG. 3 is an example of a mapping relationship between each page identifier of a checkpoint queue, an atomic operation, and an address of a log buffer area according to an embodiment of the present invention;

FIG. 4 is a schematic structural diagram of a data persistence processing apparatus according to an embodiment of the present invention;

FIG. 5 is a schematic structural diagram of another data persistence processing apparatus according to an embodiment of the present invention; and

FIG. 6 is a schematic structural diagram of a database system according to an embodiment of the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. The described embodiments are a part rather than all of the embodiments of the present invention. All other embodiments obtained by persons of ordinary skill in the art based on the embodiments of the present invention without creative efforts shall fall within the protection scope of the present invention.

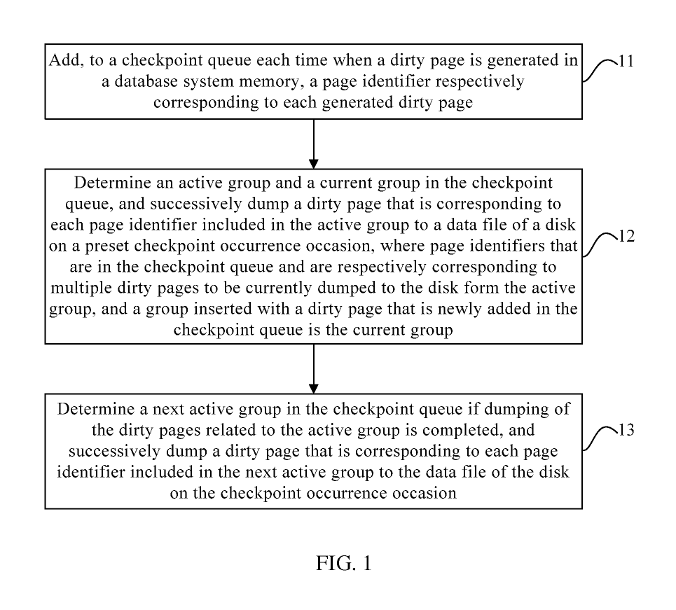

FIG. 1 is a flowchart of a data persistence processing method according to an embodiment of the present invention. As shown in FIG. 1, the data persistence processing method provided by the embodiment of the present invention includes:

11: Add, to a checkpoint queue each time when a dirty page is generated in a database system memory, a page identifier respectively corresponding to each generated dirty page.

A checkpoint queue is dynamically maintained in the database system, where the checkpoint queue is used for caching the page identifier corresponding to each dirty page generated in the database system memory. Each time when the dirty page is generated in the database system memory, the page identifier corresponding to the dirty page may be successively added to the checkpoint queue in a time sequence of generating the dirty page. After data of the dirty page corresponding to any page identifier included in the checkpoint queue is dumped to a data file of a disk from a memory, the page identifier of the dirty page is automatically deleted in the checkpoint queue.

12: Determine an active group and a current group in the checkpoint queue, and successively dump each dirty page that is corresponding to each page identifier included in the active group to a data file of the disk on a preset checkpoint occurrence occasion, where the page identifiers that are in the checkpoint queue and are respectively corresponding to multiple dirty pages to be currently dumped to the disk form the active group; and a group inserted with a dirty page that is newly added in the checkpoint queue is the current group.

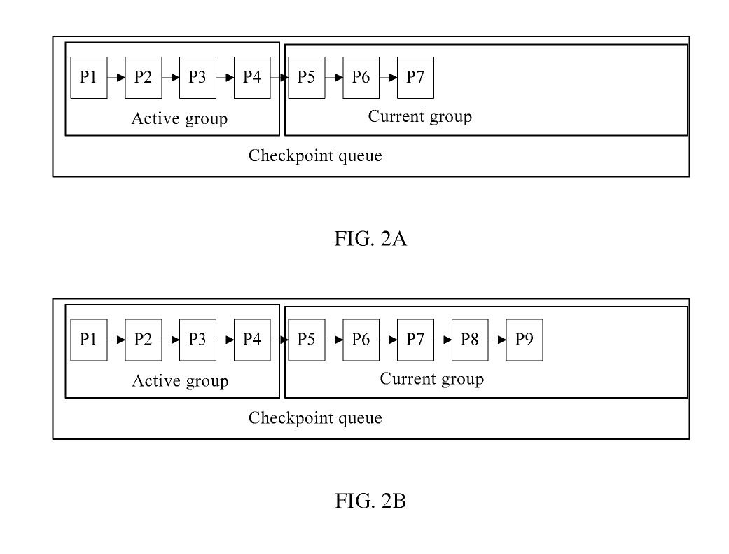

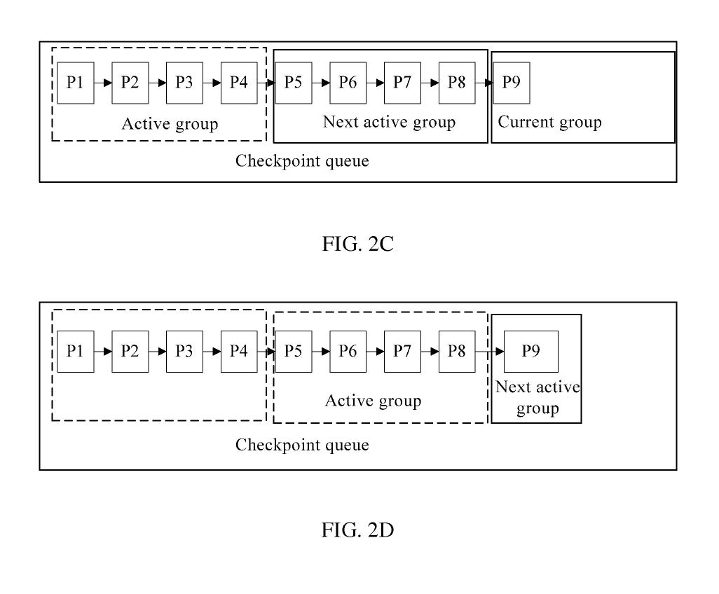

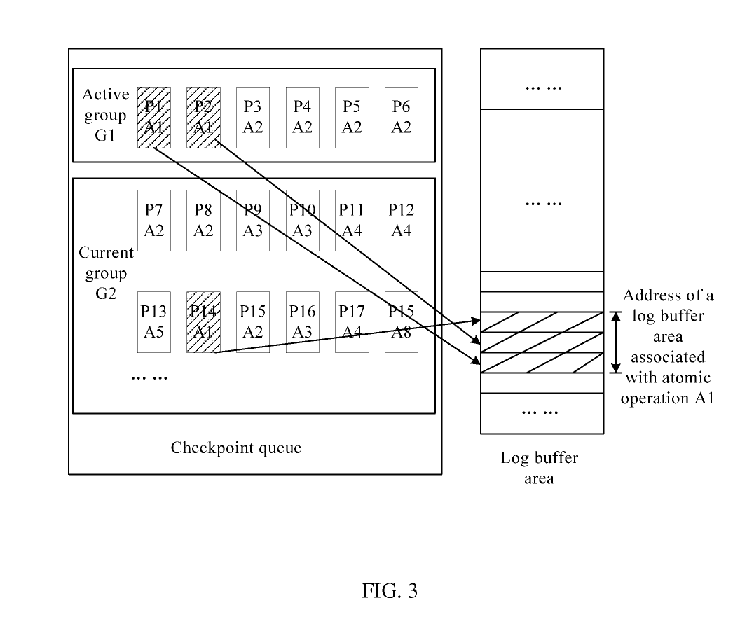

Each page identifier included in the checkpoint queue may be grouped, so as to implement dumping of the dirty pages in groups and in bulk. For example, the page identifiers that are in the checkpoint queue and are respectively corresponding to the dirty pages that require to be currently dumped to the disk form the active group, and the group inserted with the dirty page that is newly added in the checkpoint queue is the current group. In an optional implementation manner, each page identifier included in the active group may be marked with an active group identifier; after being processed in such a way, each page identifier included in the checkpoint queue are classified into two types: one is the page identifier marked with the active group identifier, namely, each page identifier included in the active group, where dirty pages corresponding to these page identifiers are the dirty pages that require to be currently dumped to the disk from the memory; and the other is page identifier without the active group identifier, namely, other page identifiers in the checkpoint queue except each page identifier included in the active group, where the other page identifiers are not marked with the active group identifier. After the active group is determined, an optional example of the current group in the checkpoint queue is shown in FIG. 2A. In this case, if a new dirty page is generated in the database system, the newly generated dirty page is successively added to the checkpoint queue in a time sequence, and a group inserted with the newly added page identifier is the current group. An optional example is shown in FIG. 2B. In FIG. 2A and FIG. 2B, four earliest added page identifiers in the checkpoint queue are used as an active group, and a determining manner of the active group is merely an exemplary description, which shall not be construed as a substantial limitation on the technologies of the present invention.

After the current active group is determined, the dirty pages corresponding to each page identifier included in the active group may be successively dumped in the data file of the disk on the checkpoint occurrence occasion, where the checkpoint occurrence occasion may be pre-determined. For example, the checkpoint occurrence occasion may be determined from a perspective of an atomic operation, so as to reduce impact of a checkpoint mechanism on a normal transaction operation.

After the dirty page corresponding to any page identifier is dumped to the data file of the disk, the page identifier may be automatically deleted in the checkpoint queue, that is, the page identifier is automatically deleted in the active group.

13: Determine a next active group in the checkpoint queue if dumping of the dirty pages related to the active group is completed, and successively dump each dirty page that is corresponding to each page identifier included in the next active group to a data file of the disk on the checkpoint occurrence occasion.

After the dirty pages corresponding to each page identifier included in the active group are dumped to the data file of the disk, the next active group may be determined in the checkpoint queue, that is, remained page identifiers in the checkpoint queue are regrouped, of which an example is shown in FIG. 2C. A dotted-line part indicates each page identifier that is included in a previous active group and have been deleted from the checkpoint queue.

If the number of the remained page identifiers in the checkpoint queue is smaller than the preset number of preset page identifiers that is preset for the active group and needs to be included in the active group, all the remained page identifiers in the checkpoint queue may be grouped into the active group. For example, as shown in FIG. 2D, the active group is preset to include 4 page identifiers, but the number of page identifier of dirty pages that have not been dumped in the checkpoint queue is 1, which is represented by P9. In this case, P9 may be directly used as a page identifier included in a new active group.

After the next active group is determined, the dirty pages corresponding to each page identifier included in the active group may be dumped to the data file of the disk on a new checkpoint occurrence occasion. In addition, a page identifier of a new dirty page generated in the memory after grouping is added to the current group. The specific implementation manner is similar to step 12, and details are not described herein again.

If the number of the remained page identifiers in the checkpoint queue is 0, that is, the checkpoint queue is empty, the foregoing steps 12 and 13 is not executed, and when a new page identifier is added to the checkpoint queue and the new checkpoint occurrence occasion arrives, the foregoing steps 12 and 13 are repeatedly executed.

In the data persistence processing method provided by the embodiment of the present invention, a checkpoint queue is maintained dynamically; page identifiers that are in the checkpoint queue and are corresponding to multiple dirty pages to be currently dumped to a disk are used as an active group, and a group inserted with a dirty page that is newly added in the checkpoint queue is a current group; on each checkpoint occurrence occasion, dirty pages corresponding to each page identifier included in an active group are successively dumped to a database of the disk; and after dumping of the dirty pages corresponding to each page identifier included in an active group is completed, a next active group is determined in the checkpoint queue, so as to successively dump each dirty page that is corresponding to each page identifier included in the next active group to a data file of the disk on a next checkpoint occurrence occasion. By circularly performing processing, dirty pages are dumped to the disk in groups and in bulk according to the checkpoint occurrence occasion, thereby improving dumping efficiency of the dirty pages on the basis that the dumping of the dirty pages has small impact on a normal transaction operation.

On the basis of the foregoing technical solutions, optionally, if it is determined that a dirty page corresponding to any page identifier included in the checkpoint queue requires to be modified, whether the any page identifier belongs to the active group is determined; if the page identifier belongs to the active group, before the dirty page corresponding to the page identifier is dumped to the data file of the disk, a mirrored page of the dirty page corresponding to the page identifier is created; and if the page identifier does not belong to the active group, the mirrored page of the dirty page corresponding to the page identifier is not created. After the mirrored page of the dirty page corresponding to the page identifier is created, if it is time dump the dirty page corresponding to the page identifier, the mirrored page corresponding to the page identifier is dumped to the data file of the disk. Processing in such a way of, a mirrored page does not require to be created for the dirty pages corresponding to each page identifier in the checkpoint queue, and a corresponding mirrored page is only created for a page identifier that is in the active group and determined for modification, thereby reducing memory space required for creating the mirrored page, and ensuring consistency between data in the memory and data in the disk.

On the basis of the foregoing technical solutions, optionally, an atomic operation may relate to a plurality of dirty pages, and an active group may include dirty pages related to a plurality of atomic operations. Before the dirty pages corresponding to each page identifier included in the active group are dumped to the data file of the disk, a log that is of each atomic operation associated with the active group and buffered in a log buffer area of the memory may be dumped to a log file of the disk. For example, an atomic operation associated with each page identifier included in the current active group is determined; an address of each log buffer area associated with the determined atomic operation is acquired from the log buffer area of the database system memory; and a log cached at the acquired address of each log buffer area is dumped to the log file of the disk. After dumping of a corresponding log is completed, the dirty pages corresponding to each page identifier included in the active group are then dumped to the data file of the disk.

FIG. 3 is used as an example for description in the following. In the example shown in FIG. 3, P represents a page identifier, A represents an atomic operation, page identifiers included in a current active group of a checkpoint queue are P1-P6, where P1, P2, and P14 are page identifiers of each dirty page related to an atomic operation A1, P1 and P2 belong to an active group, P14 belongs to an non-active group, and newest data of the dirty pages corresponding to P1, P2, and P14 is buffered at a buffer area address that is corresponding to the atomic operation A1 and in a log buffer area of a memory. In this scenario, on a checkpoint occurrence occasion, if no atomic operation is currently running in a database system memory, each log buffer area address associated with the atomic operation A1 may be acquired, and logs buffered at the acquired log buffer area address, that are, logs corresponding to P1, P2, and P14, are dumped to a log file of a disk; and then, the dirty pages corresponding to P1 and P2 are successively dumped to the log file of the disk. After the dirty pages corresponding to the page identifiers P1-P6 included in the active group are all dumped to a data file of the disk, a next active group is determined in remained page identifiers of the checkpoint queue, and an operation similar to the foregoing operation is executed when a next checkpoint occurrence occasion arrives. Processing in this way is good for ensuring correctness of recovered data when the database system recovers from a fault based on the disk.

FIG. 3 is still used as an example for description again in the following. For example, the page identifiers involved in the atomic operation A1 are the dirty pages P1, P2, and P14. Assume that the atomic operation A1 is to transfer 100 yuan from a user account U1 to a user account U2, where the dirty pages corresponding to P1 and P2 correspond to an operation of deducting 100 yuan from the user account U1 in the atomic operation, and the dirty page corresponding to P14 corresponds to an operation of adding 100 yuan to the user account U2 in the atomic operation. The log buffer area records balances of the user accounts U1 and U2; for example, the balance of the user account U1 corresponding to P1 is 100 while the balance of the user account U2 corresponding to P1 is 0, the balance of the user account U1 corresponding to P2 is 0 while the balance of the user account U2 corresponding to P2 is 0, and the balance of the user account U1 corresponding to P14 is 0 while the balance of the user account U2 corresponding to P14 is 100. If the database system encounters a fault after the dirty pages corresponding to P1 and P2 are dumped to a data file of the disk, in this case, when the database system that encounters a fault requires to be recovered based on information stored in the disk, corresponding data related to the atomic operation A1 in the database system may be recovered according to data of P1 and P2 in the data file of the disk. At this moment, recovered data displays that the balance of the user account U1 is 0 while the balance of the user account U2 is 0. Then, based on logs involved in the atomic operation A1 in the log file of the disk, the corresponding data involved in the recovered atomic operation A1 in the database system is updated. For example, based on the log that is corresponding to P14 and stored in the log file of the disk, that is, the balance of the user account U1 is 0 while the balance of the user account U2 is 100, the balance of the user account U2 in the foregoing recovered data is updated to 100. Thereby ensuring correctness of recovered data when the database system recovers from a fault based on the disk.

Further, optionally, after dumping of a dirty page of the active group is completed, and a next active group is determined, a log-file starting point of each atomic operation that is associated with each page identifier included in the next active group is required, where the log-file starting point of any atomic operation is used to indicate a log that is generated when the any atomic operation starts running and a storage location in the log file; and storing each log included in the log file in a time sequence. A minimum value of the acquired log-file starting point of each atomic operation is set to a database recovery point, where the database recovery point is used to indicate: if the database system encounters a fault before completing dumping of the dirty pages corresponding to the page identifiers included in the next active group to the disk, a starting point for recovering the required log is read in the log file when the database system encountering the fault is being recovered. Processing in such a way, a log required for database recovery may be determined quickly according to the recovery point, thereby improving a speed of database system recovery. For example, in FIG. 3, after dumping of the dirty pages corresponding to the page identifiers P1-P6 included in a current active group G1 to the disk is completed, log-file starting points of the atomic operations A2, A3, and A4 associated with a next active group G2 are acquired, and a minimum value of each obtained log-file starting point is used as a current database recovery point. If the database system encounters a fault during a process of executing an operation of transferring and storing a dirty page of the active group G2, and the current database recovery point is used as a starting point for reading a log required for the recovery in the log file when the database system performs recovery, each log after the recovery point in the log file may be determined to be a log required for database recovery.

It should be noted that, to make the description brief, the foregoing method embodiments are described as a series of action combinations. However, persons skilled in the art should understand that the present invention is not limited to the described sequence of the actions, because some steps may be performed in other order or simultaneously according to the present invention. In addition, persons skilled in the art should also understand that the embodiments described in the specification all belong to exemplary embodiments and the involved actions and modules are not necessarily mandatory to the present invention.

In the foregoing embodiments, description of each embodiment has its emphasis. For a part that is not described in detail in a certain embodiment, reference may be made to related description in another embodiment.

Persons of ordinary skill in the art may understand: all or a part of the steps of the foregoing method embodiments may be implemented by a program instructing relevant hardware. The foregoing program may be stored in a computer readable storage medium. When the program runs, the steps included in the foregoing method embodiments are performed. The foregoing storage medium includes any medium that can store program code, such as a read-only memory (ROM), a random access memory (RAM), a magnetic disk, or an optical disc.

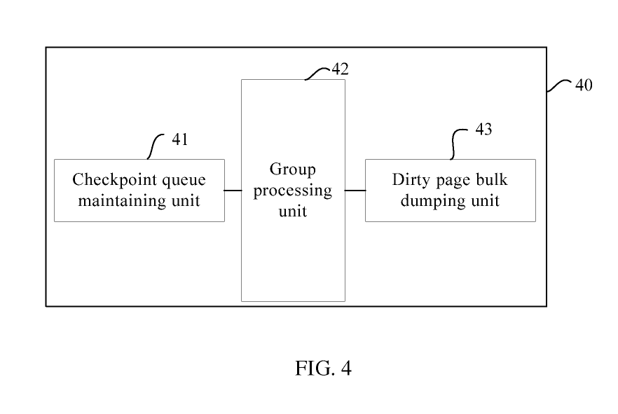

FIG. 4 is a schematic structural diagram of a data persistence processing apparatus according to an embodiment of the present invention. Specifically, a data persistence processing apparatus 40 shown in FIG. 4 includes: a checkpoint queue maintaining unit 41, a group processing unit 42, and a dirty page bulk dumping unit 43, where the checkpoint queue maintaining unit 41 may be configured to add, to a checkpoint queue each time when a dirty page is generated in a database system memory, a page identifier respectively corresponding to each generated dirty page; the group processing unit 42 may be configured to determine an active group and a current group in the checkpoint queue, where the page identifiers that are in the checkpoint queue and are respectively corresponding to multiple dirty pages to be currently dumped to a disk form the active group, and a group inserted with a dirty page that is newly added in the checkpoint queue is the current group; and the dirty page bulk dumping unit 43 may be configured to successively dump, to a data file of the disk, each dirty page that is corresponding to each page identifier included in the active group on a preset checkpoint occurrence occasion.

The group processing unit 42 may be further configured to determine a next active group in the checkpoint queue if dumping of the dirty pages related to the active group is completed.

The dirty page bulk dumping unit 43 may be further configured to successively dump, to a data file of the disk, each dirty page that is corresponding to each page identifier included in the next active group on the checkpoint occurrence occasion.

To ensure coherence of atomic operations running in the database system memory, the checkpoint occurrence occasion includes: an atomic operation that is not currently running in the database system memory.

By using the foregoing data persistence processing apparatus, dirty pages may be dumped in groups and in bulk to a data file of the disk according to the checkpoint occurrence occasion, thereby minimizing impact on a normal transaction process during a process of executing a checkpoint, and improving dumping efficiency of the dirty pages.

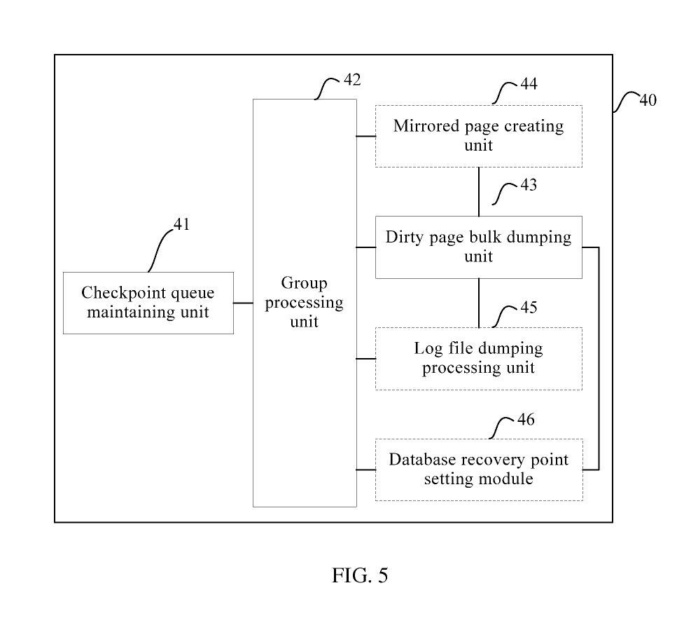

As shown in FIG. 5, on the basis of the foregoing technical solutions, optionally, the data persistence processing apparatus 40 further includes: a mirrored page creating unit 44. The mirrored page creating unit 44 may be configured to, after the active group is determined, if it is determined that a dirty page corresponding to any page identifier included in the checkpoint queue requires to be modified, determine whether the any page identifier belongs to the active group; if the any page identifier belongs to the active group, before the dirty page corresponding to the any page identifier is dumped to the data file of the disk, create a mirrored page of the dirty page corresponding to the any page identifier; and if the any page identifier does not belong to the active group, skip creating the mirrored page of the dirty page corresponding to the any page identifier. The mirrored page requires to be created only when the dirty page corresponding to the page identifier included in the current active group is modified, thereby saving storage space required for storing the mirrored page. When a dirty page corresponding to any page identifier requires to be transferred from the memory and stored in the disk, if a mirrored page is created for the page identifier, the dirty page bulk dumping unit 43 dumps the mirrored page corresponding to the page identifier to the data file of the disk from the memory.

On the basis of the foregoing technical solutions, optionally, the data persistence processing apparatus 40 further includes a log file dumping processing unit 45. The log file dumping processing unit 45 is configured to: determine an atomic operation associated with each page identifier included in the active group; acquire, an address of each log buffer area associated with the atomic operation in a log buffer area of the database system memory; and dump, to a log file of the disk, a log buffered at the acquired address of each log buffer area. Processing in this way is good for ensuring correctness of recovered data when the database system recovers from a fault based on the disk.

Further, optionally, the data persistence processing apparatus 40 further includes: a database recovery point setting module 46. The database recovery point setting module 46 may be configured to: acquire a log-file starting point of each atomic operation that is associated with each page identifier included in the next active group, where the log-file starting point of any atomic operation is used to indicate a log that is generated when the any atomic operation starts running and a storage location in the log file; and store each log included in the log file in a time sequence; and set a minimum value of the acquired log-file starting point of each atomic operation to a database recovery point, where the database recovery point is used to indicate: if the database system encounters a fault before completing dumping the dirty pages corresponding to the page identifiers included in the next active group to the disk, a starting point for recovering the required log is read in the log file when the database system encountering the fault is being recovered. Processing in such a way, a log required for database recovery may be determined quickly according to the recovery point, thereby improving a speed of database system recovery.

The data persistence processing apparatus provided by the embodiment of the present invention is configured to implement the data persistence processing method provided by this embodiment of the present invention. For a working mechanism of the apparatus, reference may be made to a corresponding record in the foregoing method embodiments of the present invention, and details are not described herein again.

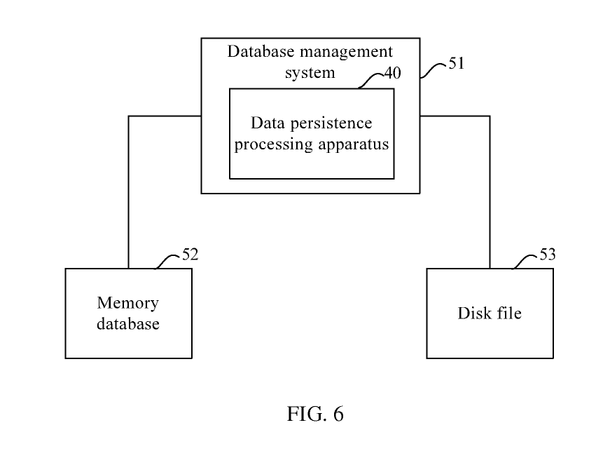

As shown in FIG. 6, an embodiment of the present invention further provides a database system, including a disk file 53, a memory database 52, and a database management system 51. The database management system 51 is used for managing data stored in the memory database 52, the database management system 51 includes any one of the foregoing data persistence processing apparatus 40, and the data persistence processing apparatus 40 is configured to dump the data stored in the memory database 52 to the disk file 53 (that is, a data file that is stored in a disk), so as to dump dirty pages in groups and in bulk to the disk according to a checkpoint occurrence occasion, thereby improving dumping efficiency of the dirty pages on the basis that the dumping of the dirty page has small impact on a normal transaction operation. For specific module division and functional method process of the data persistence processing apparatus 40, reference may be made to the foregoing embodiments, and details are not described herein again.

The solutions of the present invention may be described in a general context of a computer-executable instruction executed by a computer, for example, a program unit. Generally, the program unit includes a routine, a program, an object, a component, a data structure, and the like, which execute a specific task or implements a specific abstract data type. The solutions of the present invention may also be implemented in a distributed computing environment. In the distributed computing environment, a task is executed by a remote processing device connected by using a communications network. In the distributed computing environment, the program unit may be located in a storage medium of a local or remote computer including a storage device.

In addition, each functional unit in the embodiments of the present invention may be integrated into one unit, or may exist alone physically, or two or more functional units are integrated into one unit. The foregoing integrated unit may be implemented in a form of hardware or in a form of a software functional unit, or may be implemented in a form of hardware plus a software functional unit.

The embodiments of the present specification are described in a progressive manner. The same or similar parts of the embodiments can be referenced mutually. The focus of each embodiment is placed on a difference from other embodiments. Especially, for the apparatus embodiments, as they are fundamentally similar to the method embodiments, their description is simplified, and for relevant parts, reference may be made to the description of the method embodiments. The described apparatus embodiments are merely exemplary. The units described as separate parts may or may not be physically separate, and parts displayed as units may or may not be physical units, may be located in one position, or may be distributed on a plurality of network units. A part or all of the modules may be selected according to an actual need to achieve the objectives of the solutions of the embodiments. Persons of ordinary skill in the art may understand and implement the embodiments of the present invention without creative efforts.

Persons of skilled in the art may understand that the modules in the apparatuses provided in the embodiments may be distributed in the apparatuses according to the descriptions of the embodiments, or may be arranged in one or more apparatuses which are different from those described in the embodiments. Units in the foregoing embodiments may be integrated into one unit, or may further split into multiple sub-modules. When the functions are implemented in a form of a software functional unit and sold or used as an independent product, the functions may be stored in a computer-readable storage medium. Based on such an understanding, the technical solutions of the present invention essentially, or the part contributing to the prior art, or a part of the technical solutions may be implemented in a form of a software product. The software product is stored in a storage medium, and includes several instructions for instructing a computer device (which may be a personal computer, a server, or a network device) to perform all or a part of the steps of the methods described in the embodiments of the present invention. The foregoing storage medium includes any medium that can store program code, such as a universal serial bus (USB) flash drive, a removable hard disk, a ROM, a RAM, a disk, or an optical disc.

Persons skilled in the art may understand that, the accompanying drawings are merely schematic drawings of embodiments, and modules or procedures in the accompanying drawings are not necessarily required for implementing the present invention.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A data persistence processing method, comprising:
adding, to a checkpoint queue each time when a dirty page is generated in a database system memory, a page identifier respectively corresponding to each generated dirty page;
determining an active group and a current group in the checkpoint queue, wherein the page identifiers that are in the checkpoint queue and are respectively corresponding to multiple dirty pages to be currently dumped to a disk form the active group, and a group inserted with a dirty page that is newly added in the checkpoint queue is the current group;
successively dumping, to a data file of the disk, dirty page that is corresponding to each page identifier comprised in the active group on a preset checkpoint occurrence occasion;
determining a next active group in the checkpoint queue when dumping of the dirty pages related to the active group is completed; and
successively dumping, to the data file of the disk, each dirty page that is corresponding to each page identifier comprised in the next active group on the checkpoint occurrence occasion.

2. The method according to claim 1, wherein after determining the active group, the method further comprises:
determining whether any page identifier belongs to the active group when a dirty page corresponding to the any page identifier comprised in the checkpoint queue requires to be modified;
creating a mirrored page of the dirty page corresponding to the any page identifier before the dirty page corresponding to the any page identifier is dumped to the data file of the disk when the any page identifier belongs to the active group; and
skipping creating the mirrored page of the dirty page corresponding to the any page identifier when the any page identifier does not belong to the active group.

3. The method according to claim 1, wherein the checkpoint occurrence occasion comprises an atomic operation that is not currently running in the database system memory.

4. The method according to claim 1, wherein before successively dumping, to the data file of the disk, each dirty page that is corresponding to each page identifier comprised in the active group, the method further comprises:
determining an atomic operation associated with each page identifier comprised in the active group;
acquiring an address of each log buffer area associated with the atomic operation in a log buffer area of the database system memory; and
dumping, to a log file of the disk, a log buffered at the acquired address of each log buffer area.

5. The method according to claim 4, wherein after successively dumping, to the data file of the disk, each dirty page that is corresponding to each page identifier comprised in the current active group, and determining the next active group, the method further comprises:
acquiring a log-file starting point of each atomic operation that is associated with each page identifier comprised in the next active group, wherein the log-file starting point of any atomic operation is used to indicate a log that is generated when the any atomic operation starts running and a storage location in the log file, and storing each log comprised in the log file in a time sequence; and
setting a minimum value of the acquired log-file starting point of each atomic operation to a database recovery point, wherein the database recovery point is used to indicate a starting point for recovering the required log is read in the log file when the database system encountering a fault is being recovered and the database system encounters the fault before completing dumping the dirty pages corresponding to the page identifiers comprised in the next active group of the disk.

6. A data persistence processing apparatus, comprising:
a checkpoint queue maintaining unit configured to add, to a checkpoint queue each time when a dirty page is generated in a database system memory, a page identifier respectively corresponding to each generated dirty page;
a group processing unit configured to determine an active group and a current group in the checkpoint queue, wherein the page identifiers that are in the checkpoint queue and are respectively corresponding to multiple dirty pages to be currently dumped to a disk form the active group, and a group inserted with a dirty page that is newly added in the checkpoint queue is the current group; and
a dirty page bulk dumping unit configured to successively dump, to a data file of the disk, each dirty page that is corresponding to each page identifier comprised in the active group on a preset checkpoint occurrence occasion,
wherein the group processing unit is further configured to determine a next active group in the checkpoint queue when dumping of the dirty pages related to the active group is completed, and
wherein the dirty page bulk dumping unit is further configured to successively dump, to a data file of the disk, each dirty page that is corresponding to each page identifier comprised in the next active group on the checkpoint occurrence occasion.

7. The apparatus according to claim 6, further comprising a mirrored page creating unit configured to, after the active group is determined:
determine whether any page identifier belongs to the active group when a dirty page corresponding to the any page identifier comprised in the checkpoint queue requires to be modified;
create a mirrored page of the dirty page corresponding to the any page identifier before the dirty page corresponding to the any page identifier is dumped to the data file of the disk and when the any page identifier belongs to the active group; and
skip creating the mirrored page of the dirty page corresponding to the any page identifier when the any page identifier does not belong to the active group.

8. The apparatus according to claim 6, wherein the checkpoint occurrence occasion comprises an atomic operation that is not currently running in the database system memory.

9. The apparatus according to claim 6, further comprising a log file dumping processing unit configured to:
determine an atomic operation associated with each page identifier comprised in the active group;
acquire an address of each log buffer area associated with the atomic operation in a log buffer area of the database system memory; and
dump, to a log file of the disk, a log buffered at the acquired address of each log buffer area.

10. The apparatus according to claim 9, further comprising a database recovery point setting module configured to:
acquire a log-file starting point of each atomic operation that is associated with each page identifier comprised in the next active group, wherein the log-file starting point of any atomic operation is used to indicate a log that is generated when the any atomic operation starts running and a storage location in the log file;
store each log comprised in the log file in a time sequence; and
set a minimum value of the acquired log-file starting point of each atomic operation to a database recovery point, wherein the database recovery point is used to indicate a starting point for recovering the required log is read in the log file when the database system encountering a fault is being recovered and when the database system encounters the fault before completing dumping the dirty pages corresponding to the page identifiers comprised in the next active group to the disk.

11. A database system, comprising:
a disk file;
a memory database; and
a database management system,
wherein the database management system is configured to manage data stored in the memory database,
wherein the database management system comprises a data persistence processing apparatus,
wherein the data persistence processing apparatus is configured to:
add, to a checkpoint queue each time when a dirty page is generated in the memory database, a page identifier respectively corresponding to each generated dirty page;
determine an active group and a current group in the checkpoint queue, wherein the page identifiers that are in the checkpoint queue and are respectively corresponding to multiple dirty pages to be currently dumped to the disk file form the active group, and wherein a group inserted with a dirty page that is newly added in the checkpoint queue is the current group;
successively dump, to the disk file, dirty page that is corresponding to each page identifier comprised in the active group on a preset checkpoint occurrence occasion;
determine a next active group in the checkpoint queue when dumping of the dirty pages related to the active group is completed; and
successively dump, to the disk file, each dirty page that is corresponding to each page identifier comprised in the next active group on the checkpoint occurrence occasion.
